(19) United States
(12) Patent Application Publication
(10) Pub. No.: US 2026/0328396 A1
(43) Pub. Date: Oct. 22, 2026

(54) DRAWER-TYPE MICROWAVE OVEN

(71) Applicants: Guangdong Galanz Enterprises Co., Ltd., Foshan City (CN); Guangdong Galanz Appliances Manufacturing Co., Ltd., Zhongshan City (CN); Guangdong Galanz Microwave Oven and Electrical Appliances Manufacturing Co., Ltd., Foshan City (CN)

(72) Inventors: Liang Wang FENG, Foshan City (CN); Feng LI, Foshan City (CN); Xiao Qiang CHEN, Foshan City (CN)

(21) Appl. No.: 19/653,646

(22) Filed: Apr. 21, 2026

(30) Foreign Application Priority Data
Apr. 21, 2025 (CN) 202520750989.1

(51) Int. Cl. F24C 7/02; H05B 6/64

(52) U.S. Cl. CPC F24C 7/02; H05B 6/6402; H05B 6/6414; H05B 6/6473

(57) ABSTRACT

A drawer-type microwave oven including a housing and a cooking cavity, wherein a hot air assembly is disposed atop or beside the cooking cavity for heat and circulation. A fan and a magnetron are at a rear of the cavity with the magnetron positioned on an outlet of the fan. The housing includes a rear panel and a bottom plate, wherein the rear panel and/or the bottom plate has an inlet, an inverter board between the inlet and an outlet of the fan, and the inverter board is connected to the magnetron. The drawer-type microwave oven of the present disclosure dissipates heat from the inverter board and the magnetron through the fan, while utilizing a negative pressure formed within a chamber to cause a portion of external air to enter the chamber and dissipate heat from an electronic control board, thereby satisfying heat dissipation requirements with a single fan.

### CROSS-REFERENCE TO RELATED APPLICATION(S)

This application claims priority to Chinese Patent Application No. 202520750989.1 filed with the China National Intellectual Property Administration (CNIPA) on Apr. 21, 2025, the disclosure of which is incorporated fully herein by reference in its entirety.

### TECHNICAL FIELD

The present disclosure relates to the technical field of household appliances, and more particularly, to a drawer-type microwave oven.

### BACKGROUND ART

With the increasing demand for kitchen appliance integration and space optimization, drawer-type microwave ovens have gradually become important equipment in modern residential and commercial kitchens due to their built-in installation and space-saving characteristics. Among these, drawer-type microwave ovens equipped with hot air circulation assemblies are widely favored for their ability to diversify cooking functions and enhance kitchen aesthetics. Since drawer-type microwave ovens are typically embedded within kitchen spaces and are constrained by slide rail installation space and user push-pull operation requirements, the heat accumulation problem of the cooking cavity and components such as the magnetron and high-voltage transformer is particularly prominent, having become one of the key bottlenecks restricting their operational stability and safety.

### SUMMARY OF THE INVENTION

The problem addressed by the present disclosure is the poor heat dissipation performance of components caused by unreasonable structural design of existing drawer-type microwave ovens.

To solve the above problem, the present disclosure provides a drawer-type microwave oven comprising a housing and a cooking cavity, wherein a hot air assembly is disposed at a top or a side of the cooking cavity for heating and driving air circulation within the cooking cavity, a fan assembly and a magnetron are disposed at a rear side of the cooking cavity, wherein the magnetron is positioned on an air outlet passage of the fan assembly; the housing comprises a rear panel and a bottom plate connected to each other, wherein the rear panel and/or the bottom plate is provided with a first air inlet structure on , an inverter board is disposed between the first air inlet structure and an outlet end of the fan assembly, and the inverter board is connected to the magnetron.

Preferably, the first air inlet structure comprises a first ventilation hole disposed on at least one of the rear panel and/or the bottom plate. Preferably, a portion of the rear panel protrudes toward a side away from the cooking cavity to form a protrusion. Preferably, the housing further comprises a left side panel and a right side panel, and the first air inlet structure further comprises a second ventilation hole disposed on the left side panel or the right side panel. Preferably, the cooking cavity comprises a cavity rear plate, the drawer-type microwave oven further comprises a vertically disposed partition, two sides of the partition are respectively connected to the cavity rear plate and the rear panel, the partition cooperates with the fan assembly and divides a rear region of the cooking cavity to form a first chamber and a second chamber, and the fan assembly is disposed at an upper portion of the first chamber for driving external air to sequentially enter the first chamber and the second chamber through the first air inlet structure to form a first heat dissipation air duct.

Preferably, the cooking cavity comprises a cavity front plate, the cavity front plate is provided with an air outlet on a side proximate to the fan assembly, a second heat dissipation air duct is formed between an outgoing airflow of the second chamber and the air outlet, the drawer-type microwave oven further comprises a lighting assembly, and the lighting assembly is located within the second heat dissipation air duct.

Preferably, the second chamber is provided with a second air inlet structure and an air guiding port, the second air inlet structure is located on the bottom plate and disposed proximate to the partition, the air guiding port is located on a side of the cavity rear plate distal from the fan assembly, a third heat dissipation air duct is formed between the second air inlet structure and the air guiding port, an electronic control board is disposed within the third heat dissipation air duct, and a fourth heat dissipation air duct is formed between the air guiding port and the air outlet.

Preferably, the cooking cavity comprises a U-shaped frame, the U-shaped frame is provided with a first air inlet and a first air outlet at an end proximate to the cavity front plate, the first air inlet is connected to the fourth heat dissipation air duct, an air deflector is disposed at a side portion of the cooking cavity, the air deflector covers the first air outlet, and an outlet end of the air deflector is disposed proximate to the air outlet.

Preferably, a horizontally disposed mounting plate is provided at a top of the first chamber, one side of the mounting plate is connected to the right side panel and the cavity rear plate, a waveguide housing is disposed at a top of the cooking cavity, another side of the mounting plate is fixedly connected to the waveguide housing, and a gap exists between the mounting plate and the fan assembly.

Preferably, the hot air assembly comprises a circulation assembly and a heating assembly respectively located at a rear portion and a side portion of the cooking cavity, the circulation assembly, the heating assembly, and the cooking cavity are in mutual communication with each other, and there are two heating assemblies located on left and right sides of the cooking cavity.

Preferably, the cooking cavity comprises a cavity bottom plate and a U-shaped frame connected to each other, thermal insulation brackets are disposed on outer sides of both the cavity bottom plate and the U-shaped frame, and thermal insulation members are disposed between the thermal insulation brackets and the cavity bottom plate as well as the U-shaped frame.

Preferably, the drawer-type microwave oven further comprises a door assembly, both the housing and the cooking cavity are provided with openings corresponding to the door assembly, and the door assembly operably covers the openings.

Compared with the prior art, the drawer-type microwave oven according to the embodiment of the present disclosure has the following beneficial effects: 1 heat dissipation for the inverter board and the magnetron is achieved through the fan assembly, while a negative pressure suction effect formed within the second chamber causes a portion of external air to enter the second chamber and dissipate heat from the electronic control board; 2 a portion of the airflow after heat dissipation passes over the top of the cavity and dissipates heat from the drive motor of the stirring device and the lighting assembly, while another portion passes through the side of the cavity and dissipates heat from the drive motor and the micro switch; 3 the second heat dissipation air duct on the side of the cooking cavity enables the pressure at the first air inlet to be higher than the pressure at the first air outlet, thereby causing a small portion of air to enter the cooking cavity to expel generated oil droplets, water vapor, and the like, resulting in excellent user experience.

### BRIEF DESCRIPTION OF THE DRAWINGS

FIG. 1 is a schematic diagram of the drawer-type microwave oven according to the present disclosure in an open state;

FIG. 2 is a schematic diagram of the overall structure of the drawer-type microwave oven according to the present disclosure;

FIG. 3 is a schematic structural diagram of the drawer-type microwave oven according to the present disclosure with the rear panel hidden;

FIG. 4 is a schematic structural diagram of the drawer-type microwave oven according to the present disclosure with the top plate hidden from the rear side;

FIG. 5 is a schematic structural diagram of the drawer-type microwave oven according to the present disclosure with the left side panel hidden;

FIG. 6 is a schematic diagram of the longitudinal cross-section along line A-A in FIG. 2;

FIG. 7 is a schematic diagram of the internal structure of the drawer-type microwave oven according to an embodiment of the present disclosure.

### REFERENCE NUMERALS

100-cabinet; 101-first air inlet structure; 102-second air inlet structure; 10-housing; 11-top plate; 12-left side panel; 13-right side panel; 14-rear panel; 141-protrusion; 15-bottom plate; 16-partition; 17-mounting plate; 20-cooking cavity; 21-cavity rear plate; 211-air guiding port; 22-cavity front plate; 221-air outlet; 23-U-shaped frame; 231-first air inlet; 232-first air outlet; 24-cavity bottom plate; 25-air deflector; 26-thermal insulation bracket; 30-first chamber; 31-fan assembly; 40-second chamber; 41-magnetron; 42-electronic control board; 50-hot air assembly; 51-circulation assembly; 52-heating assembly; 60-lighting assembly; 70-drive motor; 80-guide rail assembly; 90-waveguide housing; 200-door assembly; 300-control box.

### DETAILED DESCRIPTION OF THE EMBODIMENTS

In order to make the above objectives, features, and advantages of the present disclosure more clearly understood, detailed descriptions of specific embodiments of the present disclosure are provided below in conjunction with the accompanying drawings. The technical features of the embodiments of the present disclosure may be combined with each other provided that no conflict arises.

It should be noted that all terms indicating direction and position in the present disclosure, such as "upper," "lower," "left," "right," "front," "rear," "vertical," "horizontal," "inner," "outer," "top," "bottom," "lateral," "longitudinal," "center," and the like, are only used to explain the relative positional relationships, connection conditions, and the like among components under a specific state (as shown in the accompanying drawings), and are only for the convenience of describing the present disclosure, rather than requiring that the present disclosure must be constructed and operated in a specific orientation. Therefore, these terms should not be construed as limitations on the present disclosure. Additionally, descriptions involving "first," "second," and the like in the present disclosure are for descriptive purposes only, and should not be construed as indicating or implying relative importance or implicitly specifying the quantity of the indicated technical features.

In the description of the present disclosure, unless otherwise expressly specified and limited, the terms "mounted," "connected," and "coupled" should be understood in a broad sense. For example, connection may be fixed connection, detachable connection, or integral connection; may be mechanical connection; may be direct connection or indirect connection through an intermediate medium; and may be internal communication between two elements. For those of ordinary skill in the art, the specific meanings of the above terms in the present disclosure may be understood according to specific circumstances.

In the description of this specification, descriptions with reference to the terms "one embodiment," "some embodiments," "illustrative embodiment," "example," "specific example," or "some examples" mean that specific features, structures, materials, or characteristics described in conjunction with the embodiment or example are included in at least one embodiment or example of the present disclosure. In this specification, the schematic representations of the above terms do not necessarily refer to the same embodiment or example. Furthermore, the specific features, structures, materials, or characteristics described may be combined in any suitable manner in any one or more embodiments or examples.

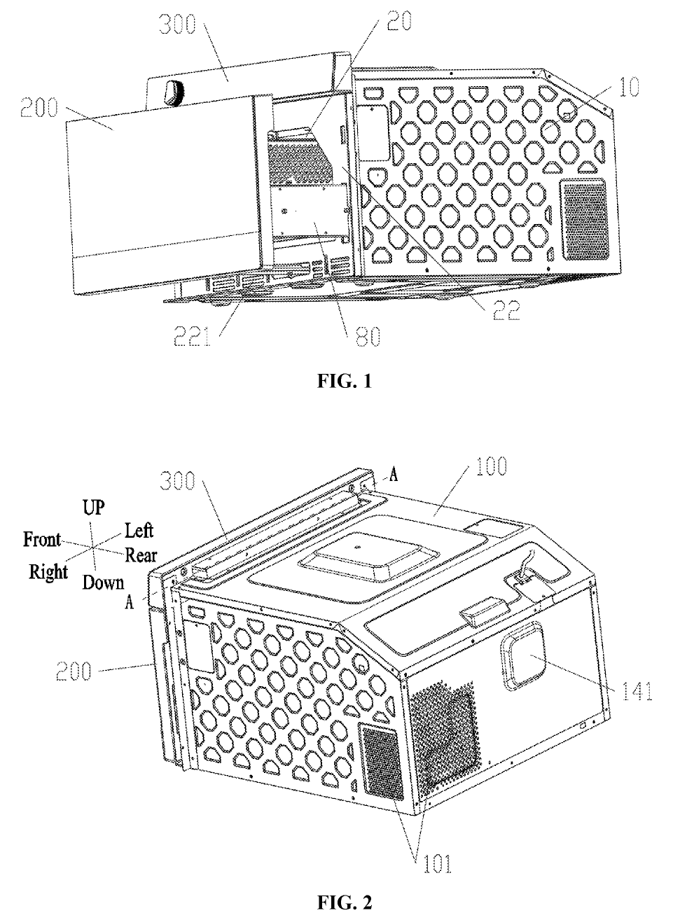

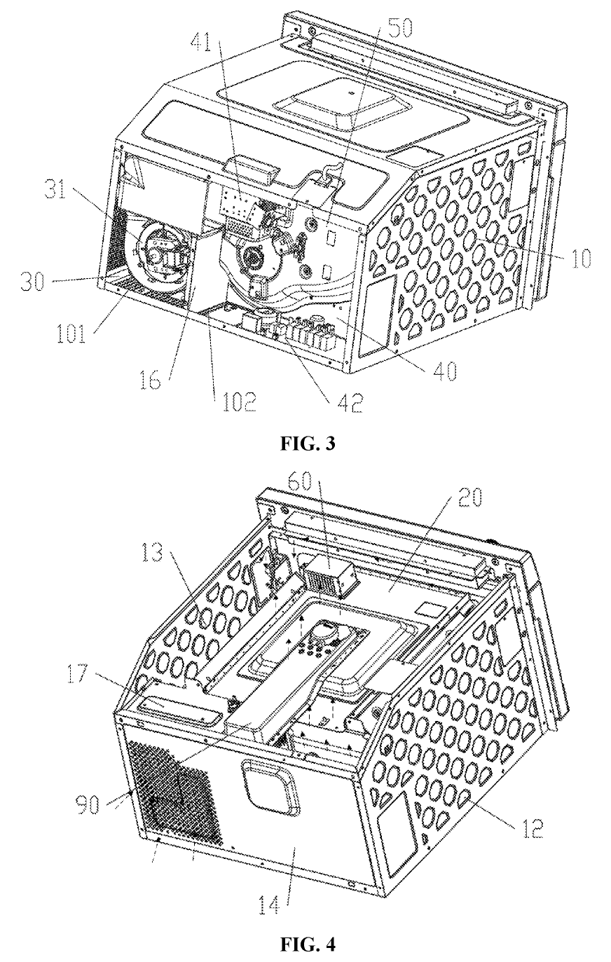

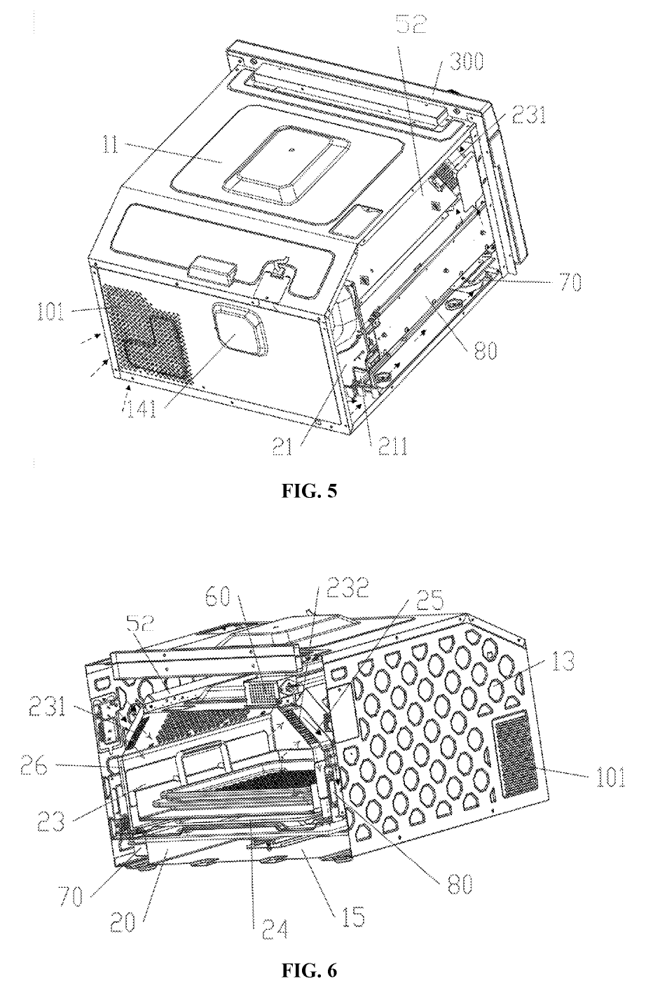

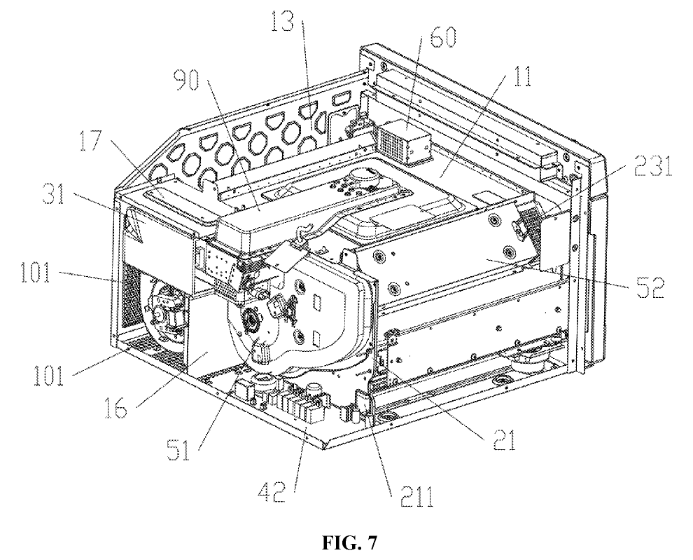

As shown in FIGS. 1-7, a drawer-type microwave oven comprises a housing 10 and a heat-insulated cavity assembly. The heat-insulated cavity assembly comprises a cooking cavity 20 and a thermal insulation bracket 26. The hot air assembly 50 is disposed at the top or side of the cooking cavity 20 for heating and driving air circulation within the cooking cavity 20. The thermal insulation bracket 26 covers the hot air assembly 50, and the thermal insulation bracket 26 also at least partially covers the cooking cavity 20. A thermal insulation member is disposed between the thermal insulation bracket 26 and the cooking cavity 20. The drawer-type microwave oven further comprises a fan assembly 31, wherein a magnetron 41 is disposed at an outlet of the fan assembly 31 for emitting microwaves into the cooking cavity 20.

This arrangement effectively prevents heat in the cooking cavity 20 from being transferred to the outside by providing the thermal insulation member, thereby achieving thermal insulation and heat blocking effects. This significantly reduces the difficulty of heat dissipation for electrical components outside the cooking cavity 20, and the heat dissipation requirements of the magnetron 41 and other components can be satisfied by a single fan assembly 31. Meanwhile, heat can also be concentrated in the cooking cavity 20, ensuring a good temperature rise rate within the cavity and enabling the required cooking temperature to be reached relatively quickly. As an example of the present disclosure, the thermal insulation member is thermal insulation cotton or a thermal insulation plate.

Preferably, the housing 10 is provided with a first air inlet structure 101, and an inverter board is disposed between the first air inlet structure 101 and the outlet end of the fan assembly 31. This arrangement allows outside air to pass through the inverter board first and then the magnetron 41 for sequential heat dissipation, satisfying the heat dissipation requirements of both the inverter board and the magnetron 41 simultaneously through a single fan assembly 31. Specifically, the inverter board has high temperature rise sensitivity but relatively low total heat generation, and cooling it first with fresh cold air can ensure that its chip junction temperature is ≤65°C. The magnetron 41, as a high-power heat source, can still be effectively cooled by the air preheated through the inverter board, resulting in a more compact structure. The inverter board may be disposed between the inlet end of the fan assembly 31 and the first air inlet structure 101, or may be disposed within the fan assembly 31.

As an example of the present disclosure, the housing 10 comprises a rear panel 14 and a bottom plate 15 connected to each other, and the first air inlet structure 101 comprises at least one first ventilation hole disposed in the rear panel 14 and/or the bottom plate 15. This arrangement provides the drawer-type microwave oven with a large air inlet area and low air inlet resistance, thereby further improving heat dissipation efficiency. Preferably, support feet are disposed below the bottom plate 15. This arrangement can ensure that a gap exists between the bottom plate 15 and the bottom wall of the built-in space, thereby facilitating entry of outside air.

Preferably, the housing 10 further includes a left side panel 12 and a right side panel 13, and the first air inlet structure 101 further includes a second ventilation hole disposed on the left side panel 12 or the right side panel 13. This configuration enables air intake simultaneously from the bottom, rear, and side portions of the drawer-type microwave oven, thereby preventing heat dissipation failure caused by blockage of individual ventilation holes and providing more stable heat dissipation.

As an example of the present disclosure, a portion of the rear panel 14 protrudes toward a side away from the cooking cavity 20 to form a protrusion 141. This configuration ensures that a gap exists between the rear panel 14 and the rear wall of the built-in space, allowing smoother air intake. The housing 10 further includes a top plate 11, and a second heat dissipation air duct is formed between the top plate 11 and the top of the cooking cavity 20.

Preferably, the cooking cavity 20 includes a cavity rear plate 21, and the drawer-type microwave oven further includes a partition 16. Two sides of the partition 16 are respectively connected to the cavity rear plate 21 and the rear panel 14. The partition 16 cooperates with the fan assembly 31 and divides a rear region of the cooking cavity 20 to form a first chamber 30 and a second chamber 40. The fan assembly 31 is disposed at an upper portion of the first chamber 30 for driving external air to sequentially enter the first chamber 30 and the second chamber 40 through the first air inlet structure 101 to form a first heat dissipation air duct.

This configuration forces airflow to enter the second chamber 40 from the first chamber 30 through the partition 16, eliminating turbulence interference of conventional open air ducts and improving the heat dissipation efficiency of the magnetron 41 by 18-22%. Meanwhile, the isolated design of the first chamber 30 ensures that the operating environment temperature of the motor of the fan assembly 31 is maintained at ≤45°C, significantly extending service life. Furthermore, the partition 16 effectively prevents vibration transmission from the fan assembly 31, preventing abnormal noise caused by resonance.

Preferably, the cooking cavity 20 includes a cavity front plate 22, the cavity front plate 22 is provided with an air outlet 221 on a side proximate to the fan assembly 31, a second heat dissipation air duct is formed between the outlet airflow of the second chamber 40 and the air outlet 221, the drawer-type microwave oven further includes a lighting assembly 60, and the lighting assembly 60 is located within the second heat dissipation air duct.

This arrangement enables air from the first heat dissipation air duct to flow out from the top of the second chamber 40 and pass over the top of the cooking cavity 20, and then be discharged from the air outlet 221 of the cavity front plate 22, thereby achieving heat dissipation for structures such as the lighting assembly 60.

Preferably, the second chamber 40 is provided with a second air inlet structure 102 and an air guiding port 211, the second air inlet structure 102 is located on the bottom plate 15 and disposed proximate to the partition 16, the air guiding port 211 is located on a side of the cavity rear plate 21 distal from the fan assembly 31, a third heat dissipation air duct is formed between the second air inlet structure 102 and the air guiding port 211, an electronic control board 42 is disposed in the third heat dissipation air duct, and a fourth heat dissipation air duct is formed between the air guiding port 211 and the air outlet 221.

This arrangement enables horizontal air discharge toward the upper portion of the second chamber 40 through the fan assembly 31, thereby forming a negative pressure zone in the lower region of the second chamber 40. External air enters the second chamber 40 through the second air inlet structure 102 under the action of negative pressure, thereby dissipating heat from the electronic control board 42. Most of the air flows out from the top of the second chamber 40, while a portion of the air flows toward the side of the cooking cavity 20 through the air guiding port 211, thereby dissipating heat from components such as the drive motor 70 located at the side of the cooking cavity 20.

Preferably, the cooking cavity 20 includes a U-shaped frame 23, and the U-shaped frame 23 is provided with a first air inlet 231 and a first air outlet 232 at an end proximate to the cavity front plate 22. The first air inlet 231 is connected to the fourth heat dissipation air duct. An air deflector 25 is disposed at a side portion of the cooking cavity 20. The air deflector 25 covers the first air outlet 232, and an outlet end of the air deflector 25 is disposed proximate to the air outlet 221. This arrangement enables a portion of air to be introduced into the cooking cavity 20 through the air pressure of the fourth heat dissipation air duct and discharged through the first air outlet 232 on the other side, thereby preventing oil droplets, water vapor, and the like generated during cooking from accumulating within the cooking cavity 20, without significantly affecting the heating and temperature rise within the cooking cavity 20. A single fan assembly 31 can simultaneously drive the flow of gas within the cooking cavity 20, resulting in low energy consumption.

Preferably, the hot air assembly 50 includes a circulation assembly 51 and a heating assembly 52 respectively located at a rear portion and a side portion of the cooking cavity 20. The circulation assembly 51, the heating assembly 52, and the cooking cavity 20 are in mutual communication. There are two heating assemblies 52 located on left and right sides of the cooking cavity 20 for discharging air obliquely downward.

This arrangement discharges hot air obliquely downward through the heating assemblies 52 on both sides, which can form a counter-flow vortex at the center of the cooking cavity 20, enabling more uniform temperature distribution. Simultaneously, this arrangement can preferentially heat the bottom of food, accelerating the rise of core temperature through heat conduction of a metal baking pan, which can significantly reduce the operation duration of functions such as defrosting, resulting in good food cooking effects. Furthermore, the hot air directed obliquely downward from both sides can form an air insulation layer at the top of the cooking cavity 20, significantly reducing upward heat conduction.

Preferably, the cooking cavity 20 includes a cavity bottom plate 24. A thermal insulation bracket 26 is disposed below the cavity bottom plate 24, and a thermal insulation member is disposed between the thermal insulation bracket 26 and the cavity bottom plate 24. This arrangement can effectively prevent heat in the cooking cavity 20 from being transferred to the bottom, ensuring that the temperature of the incoming air at the bottom of the cooking cavity 20 is relatively low, resulting in good heat dissipation effects for components.

As an example of the present disclosure, a horizontally disposed mounting plate 17 is provided at the top of the first chamber 30. One side of the mounting plate 17 is connected to the right side panel 13 and the cavity rear plate 21. A waveguide housing 90 is provided at the top of the cooking cavity 20. The other side of the mounting plate 17 is fixedly connected to the waveguide housing 90, and a gap exists between the mounting plate 17 and the fan assembly 31.

This arrangement enables the mounting plate 17 to provide a fixing position for the waveguide housing 90 and the magnetron 41, while forming a double-layer thermal insulation structure with the fan assembly 31 at the upper portion of the first chamber 30, preventing heat from the top of the cooking cavity 20 from being conducted downward and preventing adverse effects on the operational stability of the inverter board. Specifically, a rigid triangular support structure is formed by the mounting plate 17 with the right side panel 13 and the cavity rear plate 21, such that the flatness error of the waveguide housing 90 mounting surface is ≤0.05mm/m², ensuring the accuracy of the microwave emission direction.

The drawer-type microwave oven further comprises a door assembly 200 and a cabinet 100. The cabinet 100 comprises a housing 10 and a cooking cavity 20. Both the housing 10 and the cooking cavity 20 are provided with openings corresponding to the door assembly 200, and the door assembly 200 operably covers the openings. The drawer-type microwave oven further comprises a rail assembly 80 and a control box 300, the specific structures and assembly relationships of which are known in the prior art and will not be described in detail herein.

Although the present disclosure has been disclosed as above, the present disclosure is not limited thereto. Any person skilled in the art may make various changes and modifications without departing from the spirit and scope of the present disclosure. Therefore, the scope of protection of the present disclosure shall be defined by the scope of the claims.

1. A drawer-type microwave oven comprising:
a cooking cavity, wherein a hot air assembly is disposed at a top or a side of the cooking cavity for heating and driving air circulation within the cooking cavity;
a fan assembly and a magnetron are disposed at a rear side of the cooking cavity, wherein the magnetron is positioned on an air outlet channel of the fan assembly; and
a housing having a rear panel and a bottom plate connected to each other, wherein at least one of the rear panel or the bottom plate is provided with a first air inlet structure, an inverter board is disposed between the first air inlet structure and an outlet end of the fan assembly, and the inverter board is connected to the magnetron.

2. The drawer-type microwave oven according to claim 1, wherein the first air inlet structure comprises a first ventilation hole disposed on at least one of the rear panel and the bottom plate.

3. The drawer-type microwave oven according to claim 2, wherein a portion of the rear panel protrudes toward a side away from the cooking cavity to form a protrusion.

4. The drawer-type microwave oven according to claim 3, wherein the housing further comprises a left side panel and a right side panel, and the first air inlet structure further comprises a second ventilation hole disposed on the left side panel or the right side panel.

5. The drawer-type microwave oven according to claim 1, wherein the cooking cavity comprises a cavity rear plate, the drawer-type microwave oven further comprises a vertically disposed partition, two sides of the partition are respectively connected to the cavity rear plate and the rear panel, the partition cooperates with the fan assembly and divides a rear region of the cooking cavity to form a first chamber and a second chamber, the fan assembly is disposed at an upper portion of the first chamber for driving external air to sequentially enter the first chamber and the second chamber through the first air inlet structure to form a first heat dissipation air duct.

6. The drawer-type microwave oven according to claim 5, wherein the cooking cavity comprises a cavity front plate, the cavity front plate is provided with an air outlet on a side proximate to the fan assembly, a second heat dissipation air duct is formed between an outgoing airflow of the second chamber and the air outlet, the drawer-type microwave oven further comprises a lighting assembly, and the lighting assembly is located within the second heat dissipation air duct.

7. The drawer-type microwave oven according to claim 6, wherein the second chamber is provided with a second air inlet structure and an air guiding port, the second air inlet structure is located on the bottom plate and disposed proximate to the partition, the air guiding port is located on a side of the cavity rear plate distal from the fan assembly, a third heat dissipation air duct is formed between the second air inlet structure and the air guiding port, an electronic control board is disposed within the third heat dissipation air duct, and a fourth heat dissipation air duct is formed between the air guiding port and the air outlet.

8. The drawer-type microwave oven according to claim 7, wherein the cooking cavity comprises a U-shaped frame, the U-shaped frame is provided with a first air inlet and a first air outlet at an end proximate to the cavity front plate, the first air inlet is connected to the fourth heat dissipation air duct, an air deflector is disposed at a side portion of the cooking cavity, the air deflector covers the first air outlet, and an outlet end of the air deflector is disposed proximate to the air outlet.

9. The drawer-type microwave oven according to claim 5, wherein a horizontally disposed mounting plate is provided at a top of the first chamber, one side of the mounting plate is connected to a right side panel and the cavity rear plate, a waveguide housing is disposed at a top of the cooking cavity, another side of the mounting plate is fixedly connected to the waveguide housing, and a gap exists between the mounting plate and the fan assembly.

10. The drawer-type microwave oven according to claim 1, wherein the hot air assembly comprises a circulation assembly and a heating assembly located at a rear portion and side portions of the cooking cavity respectively, the circulation assembly, the heating assembly, and the cooking cavity are in mutual communication with each other, and there are two heating assemblies located on left and right sides of the cooking cavity.

11. The drawer-type microwave oven according to claim 10, wherein the cooking cavity comprises a cavity bottom plate and a U-shaped frame connected to each other, thermal insulation brackets are disposed on outer sides of both the cavity bottom plate and the U-shaped frame, and thermal insulation members are disposed between the thermal insulation brackets and the cavity bottom plate as well as the U-shaped frame.

12. The drawer-type microwave oven according to claim 1, wherein the drawer-type microwave oven further comprises a door assembly; wherein both the housing and the cooking cavity are provided with openings corresponding to the door assembly, and the door assembly operably covers the openings.
